(19) United States
(12) Patent Application Publication
(10) Pub. No.: US 2021/0102080 A1
(43) Pub. Date: Apr. 8, 2021

(54) SPRAYABLE INK FOR DIGITAL PRINTING PROCESS ON FABRIC

(71) Applicant: TAIWAN TEXTILE RESEARCH INSTITUTE, New Taipei City (TW)

(72) Inventor: Jung-Yu TSAI, NEW TAIPEI CITY (TW)

(21) Appl. No.: 17/033,985

(22) Filed: Sep. 28, 2020

(30) Foreign Application Priority Data
Oct. 3, 2019 (TW) 108135945

(51) Int. Cl. C09D 11/102

(52) U.S. Cl. CPC C09D 11/102; C08K 5/053

(57) ABSTRACT

A sprayable ink for a digital printing process on a fabric includes 29 parts by weight to 30 parts by weight of a polyurethane dispersion, 18 parts by weight to 21 parts by weight of a humectant, 1 part by weight to 2 parts by weight of a surfactant, and 47 parts by weight to 52 parts by weight of a solvent, wherein the polyurethane dispersion has a pH value between 5.4 and 8.0 and a specific gravity between 1.03 and 1.06 at 25° C.

### RELATED APPLICATION

This application claims priority to Taiwan Application Serial Number 108135945, filed Oct. 3, 2019, which is herein incorporated by reference.

### BACKGROUND

### Field of Invention

The present disclosure relates to a sprayable ink, and particularly relates to a sprayable ink for a digital printing process on a fabric.

### Description of Related Art

The traditional textile printing industry has problems with the high pollution, the high energy consumption, and the high cost, and the product quality would be unstable due to the traditional techniques for multi-layer coating on fabrics. In recent years, the rise of the digital printing process has solved the above-mentioned problems of the traditional textile printing industry. The digital printing process is a discontinuous phase coating process, in which the nozzle of the inkjet device would not contact the processed fabric, and it has the advantages of the precise positioning, the high usage rate of chemical agents, the reduction of waste discharge, the low process energy consumption, the effective cost reduction, the rapid sampling of small batches, and so on. In addition, the applicability of the processed fabric can be developed by the digital printing process through different functional coating designs, the partial coating, and the multi-layer coating on the surface or the interior of the fabrics. The digital printing process can reduce the decline in coating performance caused by traditional coatings interference. In view of the above, it is necessary to further develop a sprayable ink that can be used in the digital printing process.

### SUMMARY

The present disclosure provides a sprayable ink for a digital printing process on a fabric, which includes 29 parts by weight to 30 parts by weight of a polyurethane dispersion, 18 parts by weight to 21 parts by weight of a humectant, 1 part by weight to 2 parts by weight of a surfactant, and 47 parts by weight to 52 parts by weight of a solvent, in which the polyurethane dispersion has a pH value between 5.4 and 8.0 and a specific gravity between 1.03 and 1.06 at 25° C.

In some embodiments, the polyurethane dispersion is an aqueous polyurethane dispersion.

In some embodiments, the polyurethane dispersion includes polyester polyurethane, polyether polyurethane, a copolymer of polyester polyurethane and polyether polyurethane, a copolymer of polyester polyurethane and poly(methyl methacrylate), a copolymer of polyether polyurethane and poly(methyl methacrylate), or combinations thereof.

In some embodiments, the polyester polyurethane is aliphatic polyester polyurethane, and the polyether polyurethane is aliphatic polyether polyurethane.

In some embodiments, a viscosity of the polyurethane dispersion is between 700 cP and 1100 CP.

In some embodiments, the humectant includes glycerol and triethylene glycol, and a weight ratio of the glycerol to the triethylene glycol is between 2 and 2.5.

In some embodiments, a solid content of polyurethane in the polyurethane dispersion is between 30 wt % and 45 wt %.

In some embodiments, a polyurethane dispersion includes polyurethane, and a particle diameter (D90) of the polyurethane is between 85 nm and 350 nm.

In some embodiments, a surface tension of the sprayable ink is between 15 mN/m and 45 mN/m.

In some embodiments, a viscosity of the sprayable ink is between 3.0 cP and 6.0 cP.

These and other features, characteristics, and advantages of the present disclosure can be better understood with reference to the following description and the scope of the claims of the appended patent applications.

It should be understood that the foregoing general description and the following specific description are merely exemplary and explanatory, and are intended to provide a further description of the claimed invention.

### DETAILED DESCRIPTION

In the disclosure, a range represented by “one value to another value” is a schematic representation to avoid listing all the values in the range one by one in the specification. Therefore, the description of a specific numerical range covers any numerical value within the numerical range and the smaller numerical range defined by any numerical value within the numerical range. As in the specification, the arbitrary value and the smaller value range are clearly written.

As used herein, “about”, “approximately”, “essentially”, or “substantially” includes the stated value and the average value within the acceptable deviation range of the specific value determined by those of ordinary skill in the art. The measurement in question and the specific number of errors associated with the measurement (i.e., the limitations of the measurement system) are taken into account. For example, “about” can mean within one or more standard deviations of the stated value, or for example, within ±30%, ±20%, ±15%, ±10%, ±5%. Furthermore, the terms “about”, “approximately”, “essentially”, or “substantially” as used herein can be selected to be a more acceptable range of deviation or standard deviation based on measurement properties, coating properties, or other properties, and it is possible to apply all properties without a standard deviation.

The present disclosure provides a sprayable ink that can be sprayed on a fabric through a digital printing process to provide the fabric with moisture absorbency. The sprayable ink of the present disclosure includes 29 parts by weight to 30 parts by weight of a polyurethane dispersion, 18 parts by weight to 21 parts by weight of a humectant, 1 part by weight to 2 parts by weight of a surfactant, and 47 parts by weight to 52 parts by weight of a solvent. The polyurethane dispersion has a pH value between 5.4 and 8.0 and a specific gravity between 1.03 and 1.06 at 25° C. In some embodiments, the pH value is, for example, 5.5, 6.0, 6.5, 7.0, or 7.5, and the specific gravity is, for example, 1.04 or 1.05.

In some embodiments, a surface tension of the sprayable ink is between 15 mN/m and 45 mN/m, and the surface tension may be, for example, 20, 25, 30, 35, or 40 mN/m. In some embodiments, a viscosity of the sprayable ink is between 3.0 cP and 6.0 cP (measured by Brookfield DV2T viscometer), and the viscosity is, for example, 4 or 5 cP. When the surface tension and the viscosity of the sprayable ink are in the ranges as mentioned above, the sprayable ink has a good inkjet property, so that the sprayable ink can be smoothly ejected by the inkjet device and unlikely to block the nozzle. In some embodiments, the pH value of the sprayable ink is in a range from 5 to 7, and the pH value is, for example, 5.5, 6, or 6.5. When the pH value of the sprayable ink is in the range as mentioned above, the sprayable ink can be regarded as being neutral, so as to avoid the inkjet device from being corroded and extend the lifetime thereof.

In some embodiments, the polyurethane dispersion is an aqueous polyurethane dispersion. In some embodiments, the polyurethane dispersion includes polyester polyurethane, polyether polyurethane, a copolymer of polyester polyurethane and polyether polyurethane, a copolymer of polyester polyurethane and poly(methyl methacrylate), a copolymer of polyether polyurethane and poly(methyl methacrylate), or combinations thereof. In some embodiments, the polyester polyurethane is aliphatic polyester polyurethane, and the polyether polyurethane is aliphatic polyether polyurethane.

In some embodiments, a solid content of polyurethane in the polyurethane dispersion is between 30 wt % and 45 wt %, for example, 32, 34, 36, 38, 40, 42, or 44 wt %. In some embodiments, a viscosity of the polyurethane dispersion is between 700 cP and 1100 cP, for example, 800, 900, or 1000 cP. When the solid content and the viscosity of the polyurethane dispersion are in the ranges as mentioned above, the sprayable ink has a good inkjet property, so that the sprayable ink can be smoothly ejected by the inkjet device and unlikely to block the nozzle.

In some embodiments, the polyurethane dispersion includes a polyurethane, and the particle diameter (D90) of the polyurethane is between 85 nm and 350 nm. The particle diameter is, for example, 100, 150, 200, 250, or 300 nm. When the particle diameter of the polyurethane is in the range as mentioned above, the sprayable ink has a good inkjet property, so that the sprayable ink can be smoothly ejected by the inkjet device and unlikely to block the nozzle. Furthermore, when the particle diameter of the polyurethane is in the range as mentioned above, the sprayable ink has good solution dispersibility and stability and can be stored in a container for a long time.

In some embodiments, the humectant includes glycerol, triethylene glycol, or combinations thereof. In some embodiments, the humectant includes glycerol and triethylene glycol, and a weight ratio of the glycerol to the triethylene glycol is between 2 and 2.5. When the weight ratio of the glycerol to the triethylene glycol is in the range as mentioned above, the sprayable ink has better stability and is unlikely to be aging or become maturation. For example, the sprayable ink of the present disclosure can be stored at room temperature for up to 4 months.

In some embodiments, the surfactant includes 2,4,7,9-tetramethyl-5-decyne-4,7-diol ethoxylate, polyether-modified organosiloxane, or combinations thereof. The surface tension of the sprayable ink can be adjusted by the surfactant.

In some embodiments, the solvent includes deionized water.

In some embodiments, the sprayable ink further includes a dispersant, a thickening agent, a pH modifier, a bacteriostatic agent, or combinations thereof to adjust the applicability of the sprayable ink.

The sprayable ink of the present disclosure can be sprayed on a fabric by a digital printing process, so that the fabric has the properties of absorbing and transmitting moisture, and at the same time the fabric has air permeability. The digital printing process is more adjustable than the traditional coating method, and the moisture absorbency of the fabric can be easily adjusted through the spraying amount. The sprayed fabric can be manufactured into moisture-permeability and waterproof products, such as windbreakers, jackets, and so on. Finishing plants, coating plants, and surface treating plants can use the sprayable ink of the present disclosure to perform the inkjet coating, the inkjet finishing, the precision coating, the surface modification, and the surface and the interior differentiation treatments.

The features of the present invention will be described more specifically below with reference to Experiment 1 to Experiment 5. Although the following examples are described, the used materials, amounts and ratios, processing details, processing flow, etc. can be appropriately changed without exceeding the scope of the present invention. Therefore, the present invention should not be limitedly interpreted by these examples described below.

In the following experiments, the polyurethane dispersion 1 and the polyurethane dispersion 2 were selected and compounded respectively to form the sprayable inks.

Polyurethane dispersion 1: the pH value was 5.4 and the specific gravity was 1.03 at 25° C.

Polyurethane dispersion 2: the pH value was 8.0 and the specific gravity was 1.06 at 25° C.

### Experiment 1: Evaluation of Suitability of Polyurethane Dispersion for Compounding Ink

The polyurethane dispersion 1 (hereinafter referred to as dispersion 1) and the polyurethane dispersion 2 (hereinafter referred to as dispersion 2) were respectively mixed with glycerol and deionized water. Subsequently, those mixtures were dropped on Petri dishes and dried for a period. Observing the formability of the mixtures to evaluate whether the dispersions 1 and 2 were suitable for compounding the inks. The contents and the test results of each example were listed in Table 1 below, in which 0 represented that no film formed in the mixture, and A represented that some residue precipitated in the mixture but the mixture not completely reacted.

TABLE 1

| | | | Solvent | Drying time | |
|---|---|---|---|---|---|
| | Polyurethane | Humectant | (deionized | 12 | 24 |
| | dispersion | (glycerol) | water) | hours | hours |
| Example 1 | 30 | 10 | 60 | ◯ | Δ |
| | (dispersion 1) | | | | |
| Example 2 | 30 | 15 | 55 | ◯ | Δ |
| | (dispersion 1) | | | | |
| Example 3 | 30 | 20 | 50 | ◯ | ◯ |
| | (dispersion 1) | | | | |
| Example 4 | 30 | 10 | 60 | ◯ | Δ |
| | (dispersion 2) | | | | |
| Example 5 | 30 | 15 | 55 | ◯ | Δ |
| | (dispersion 2) | | | | |
| Example 6 | 30 | 20 | 50 | ◯ | ◯ |
| | (dispersion 2) | | | | |

Note:
The unit of contents in Table 1 is parts by weight.

It can be seen from Table 1 that the contents of Example 3 and Example 6 had a better moisturizing property and were more suitable for compounding the inks. Therefore, in the subsequent experiments, the inks would be prepared based on these two examples.

### Experiment 2: Evaluation of Sprayable Ink

The dispersion 1 was made into the sprayable water-repellent inks of Examples 7-12, and the dispersion 2 was made into the sprayable water-repellent inks of Example 13-18. The contents of the inks were listed in Table 2 below, and the various properties of the inks were listed in Table 3 below. In Table 3, the surfactant BYK-348 (hereinafter referred to as 348′), the surfactant Surfynol-465 (hereinafter referred to as 465′) and the surfactant Surfynol-485 (hereinafter referred to as 485′) were purchased from Air Products and Chemicals, Inc.

TABLE 2

| | Polyurethane | Humectant | | Solvent |
|---|---|---|---|---|
| | dispersion | (glycerol) | Surfactant | (deionized water) |
| Example 7 | 30 | 20 | 0.5 | 49.5 |
| | (dispersion 1) | | (348′) | |
| Example 8 | 30 | 20 | 1 | 49 |
| | (dispersion 1) | | (348′) | |
| Example 9 | 30 | 20 | 0.5 | 49.5 |
| | (dispersion 1) | | (465′) | |
| Example 10 | 30 | 20 | 1 | 49 |
| | (dispersion 1) | | (465′) | |
| Example 11 | 30 | 20 | 0.5 | 49.5 |
| | (dispersion 1) | | (485′) | |
| Example 12 | 30 | 20 | 1 | 49 |
| | (dispersion 1) | | (485′) | |
| Example 13 | 30 | 20 | 0.5 | 49.5 |
| | (dispersion 2) | | (348′) | |
| Example 14 | 30 | 20 | 1 | 49 |
| | (dispersion 2) | | (348′) | |
| Example 15 | 30 | 20 | 0.5 | 49.5 |
| | (dispersion 2) | | (465′) | |
| Example 16 | 30 | 20 | 1 | 49 |
| | (dispersion 2) | | (465′) | |
| Example 17 | 30 | 20 | 0.5 | 49.5 |
| | (dispersion 2) | | (485′) | |
| Example 18 | 30 | 20 | 1 | 49 |
| | (dispersion 2) | | (485′) | |

Note:
The unit of contents in Table 2 is parts by weight.

TABLE 3

| | Surface | | | |
|---|---|---|---|---|
| | tension | Viscosity | Density | |
| | (mN/m) | (cP) | (g/cm³) | pH value |
| Example 7 | 21.9 | 4.61 | 1.039 | 5-6 |
| Example 8 | 21.6 | 5.12 | 1.039 | 5-6 |
| Example 9 | 30.1 | 4.54 | 1.036 | 5-6 |
| Example 10 | 31.7 | 4.67 | 1.038 | 5-6 |
| Example 11 | 37.4 | 4.48 | 1.040 | 5-6 |
| Example 12 | 39.3 | 4.54 | 1.040 | 5-6 |
| Example 13 | 26.0 | 3.71 | 1.041 | 7 |
| Example 14 | 24.6 | 3.78 | 1.040 | 7 |
| Example 15 | 26.2 | 3.65 | 1.041 | 7 |
| Example 16 | 30.9 | 3.84 | 1.039 | 7 |
| Example 17 | 36.5 | 3.65 | 1.040 | 7 |
| Example 18 | 40.2 | 3.71 | 1.040 | 7 |

It can be seen from Table 2 and Table 3 that each of the surface tension, the viscosity, the density, and the pH value of the sprayable inks of the above Examples 7-18 was all fallen within the suitable ranges for spraying.

### Experiment 3: Aging Experiment

The sprayable inks of Example 10 and Example 16 were performed under an aging experiment at 50° C. for 7 days, and the surface tension, the viscosity, and the particle diameter (D90) of each of the sprayable inks were measured before and after the aging experiment. The results were listed in Table 4 below.

TABLE 4

| | Example 10 | Example 16 |
|---|---|---|
| Surface tension (mN/m) before | 24.0 | 27.3 |
| Surface tension (mN/m) after | 24.0 | 26.8 |
| Viscosity (cP) before | 4.35 | 3.45 |
| Viscosity (cP) after | 4.25 | 3.27 |
| Particle diameter (D90) (nm) before | 344.5 | 100.5 |
| Particle diameter (D90) (nm) after | 325.8 | 95.5 |

It can be seen from Table 4 that there was almost no difference for each of the surface tension, the viscosity and the particle diameter (D90) of the sprayable inks of Example 10 and Example 16 after the aging experiment, and those inks were still suitable for spaying. It is considered that the inks of this experiment had good stability and were unlikely to be aging or become maturation.

### Experiment 4: Evaluation of Moisture Absorbency for Fabric

The sprayable inks of Examples 19 and 20 were prepared. The ink compositions were listed in Table 5 below, in which the solvent was deionized water. The sprayable inks of the Examples 10, 19, and 20 were sprayed on the surface of the high-density polyester base cloth (basis weight: 43.8 gsm, fiber specification: 20d/24f, warp yarns density: 226 per inch, weft yarns density: 180 per inch) through Epson L310 printer to manufacture moisture-absorbing fabrics of Examples 21-23, and the moisture absorbency thereof was measured. The spraying methods and the evaluation methods for the moisture-absorbing fabrics of Examples 21-23 were listed in Table 6 below. The spraying amount was measured after the drying step at 100° C. The moisture absorbency was measured under AATCC79.

TABLE 5

| | | Humectant | | | | |
|---|---|---|---|---|---|---|
| | | | Trieth- | | | |
| | Polyurethane | | ylene | Surfactant | | Sol- |
| | dispersion | Glycerol | glycol | 348′ | 465′ | vent |
| Example | 29.6 | 13.8 | 6 | 0.5 | 1 | 49.1 |
| 19 | (dispersion 1) | | | | | |
| Example | 29.5 | 13.8 | 6 | 0.25 | 1.5 | 48.95 |
| 20 | (dispersion 2) | | | | | |

Note:
The unit of contents in Table 5 is parts by weight.

TABLE 6

| | Example 21 | Example 22 | Example 23 |
|---|---|---|---|
| Sprayable ink | Example 10 | Example 19 | Example 20 |
| Spraying method | Full-surface | Full-surface | Full-surface |
| | spraying for | spraying for | spraying for |
| | 5 times | 5 times | 10 times |
| Spraying amount | 4.5 | 4.5 | 20.5 |
| (gsm) | | | |
| Treatment after | Dried at | Dried at | Dried at |
| spraying | 100° C., | 100° C. | 100° C. |
| | cured at | and cured at | and cured at |
| | 160° C. for | 160° C. for | 160° C. for |
| | 5 minutes, | 1 minute | 1 minute |
| | washed and dried | | |
| Moisture | Good on the | Good on the | Good on the |
| absorbency | coated surface | coated surface | coated surface |
| Moisture | N/A | 108.5 | 129.8 |
| absorption time | | | |
| (sec) | | | |

It can be seen from Table 6 that the moisture absorbency of the moisture-absorbing fabrics could be adjusted by the spraying methods and the spraying amount. The sprayable inks of this experiment can provide the fabrics with good moisture absorbency.

### Experiment 5: Evaluation of Water Resistance for Fabric

The sprayable ink was sprayed on one side of the polyester base cloths through Epson L310 printer, and the water-repellent process was performed on the other side of the polyester base cloths to manufacture the fabrics with water resistance. The water resistance of the fabrics was measured by JIS L1092, and the results were listed in Table 7 below. Please refer to Table 7 below for the spraying methods of the sprayable ink. The spraying amount was measured after the drying step at 100° C. The steps of the water-repellent process were as follows. A water-repellent solution was sprayed on the polyester base cloths through the screen printing, in which the water-repellent solution contains 1 part by weight of synthetic paste, 5 parts by weight of fluorine water repellent, and 94 parts by weight of deionized water. Then, drying the fabrics at 130° C. for 3 minutes (the measured spraying amount is 2.5-3 gsm), curing the fabrics at 130° C. for 2 minutes, and removing the synthetic paste through water, followed by drying the fabrics at 160° C. for 3 minutes.

TABLE 7

| | Example 24 | Example 25 |
|---|---|---|
| Sprayable ink | Example 19 | Example 19 |
| Polyester base | White polyester base cloth | Blue polyester base cloth |
| cloth | (basis weight: 120.4 gsm) | (basis weight: 37.4 gsm) |
| Spraying method | Full-surface spraying | Full-surface spraying |
| | for 10 times | for 5 times |
| Spraying amount | 15.5 | 15.5 |
| (gsm) | | |
| Treatment after | Dried at 100° C., | Dried at 100° C., |
| spraying | cured at 160° C. | cured at 160° C. |
| | for 1 minute, | for 1 minute, |
| | washed and dried | washed and dried |
| Water resistance | 16.3 | 78.5 |
| before (mmH₂O) | | |
| Water resistance | 262.1 | 225.4 |
| after (mmH₂O) | | |

It can be seen from Table 7 that the polyester base cloths had water resistance after two sides of the polyester base cloths were respectively treated with the sprayable ink and the water-repellent solution of this experiment. The two sides of the fabrics had different properties, in which one side had moisture absorbency, and the other side had water repellency. These fabrics had wide applicability and can be manufactured into trench coats, raincoats, and other clothing. The sprayable ink in the present disclosure can be used in the digital printing process, and hence manufacturers can easily form the fabric having two sides with different properties, thereby solving the problem of the unstable quality of different functions on the surface and the interior of fabrics made by the traditional process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A sprayable ink for a digital printing process on a fabric, comprising:
29 parts by weight to 30 parts by weight of a polyurethane dispersion;
18 parts by weight to 21 parts by weight of a humectant;
1 part by weight to 2 parts by weight of a surfactant; and
47 parts by weight to 52 parts by weight of a solvent, wherein the polyurethane dispersion has a pH value between 5.4 and 8.0 and a specific gravity between 1.03 and 1.06 at 25° C.

2. The sprayable ink of claim 1, wherein the polyurethane dispersion is an aqueous polyurethane dispersion.

3. The sprayable ink of claim 1, wherein the polyurethane dispersion comprises polyester polyurethane, polyether polyurethane, a copolymer of polyester polyurethane and polyether polyurethane, a copolymer of polyester polyurethane and poly(methyl methacrylate), a copolymer of polyether polyurethane and poly(methyl methacrylate), or combinations thereof.

4. The sprayable ink of claim 3, wherein the polyester polyurethane is aliphatic polyester polyurethane, and the polyether polyurethane is aliphatic polyether polyurethane.

5. The sprayable ink of claim 1, wherein a viscosity of the polyurethane dispersion is between 700 cP and 1100 cP.

6. The sprayable ink of claim 1, wherein the humectant comprises glycerol and triethylene glycol, and a weight ratio of the glycerol to the triethylene glycol is between 2 and 2.5.

7. The sprayable ink of claim 1, wherein a solid content of polyurethane in the polyurethane dispersion is between 30 wt % and 45 wt %.

8. The sprayable ink of claim 1, wherein the polyurethane dispersion comprises polyurethane, and a particle diameter (D90) of the polyurethane is between 85 nm and 350 nm.

9. The sprayable ink of claim 1, wherein a surface tension of the sprayable ink is between 15 mN/m and 45 mN/m.

10. The sprayable ink of claim 1, wherein a viscosity of the sprayable ink is between 3.0 cP and 6.0 cP.
